(19) United States
(12) Patent Application Publication
(10) Pub. No.: US 2026/0001042 A1
(43) Pub. Date: Jan. 1, 2026

(54) METHOD FOR PREDICTING A MAINTENANCE OPERATION AND RECOMMENDING MAINTENANCE FOR WATER TREATMENT EQUIPMENT

(71) Applicant: VEOLIA WATER SOLUTIONS & TECHNOLOGIES SUPPORT, Saint Maurice Cedex (FR)

(72) Inventors: Claire VENTRESQUE, Colombes (FR); Marie GAVERIAUX, Bagnolet (FR); Remi CUINGNET, Saint Prix (FR)

(21) Appl. No.: 19/119,716

(22) PCT Filed: Oct. 9, 2023
(86) PCT No.: PCT/EP2023/077864

§ 371 Date: Apr. 9, 2025

(30) Foreign Application Priority Data
Oct. 10, 2022 (FR) FR2210377

(51) Int. Cl. B01D 65/10; B01D 65/02; C02F 1/00; C02F 103/08; G06N 3/044; G06Q 10/20

(52) U.S. Cl. CPC B01D 65/102; B01D 65/02; C02F 1/008; G06N 3/044; G06Q 10/20; B01D 2311/10; B01D 2311/14; B01D 2315/20; B01D 2321/40; C02F 2103/08; C02F 2303/14

(57) ABSTRACT

The present invention relates to a method for automated data processing to assess the state of multiple filtration membranes used in liquid filtration. The method involves receiving data from state sensors positioned within or near a set of membranes, which process incoming water into permeate and concentrate flows. This data, collected as time series at predefined frequencies, pertains to external physical parameters. An operating indicator is determined from this data, forming a second time series. Both the first and second time series are recorded as point clouds over a specified acquisition period. An intermediate operating indicator is generated, representing the state of new, clean, or cleaned membranes, using a learned normalization model. Finally, a normalized operating indicator is produced, characterizing membrane fouling and aging, independent of environmental variations, and forming a third time series. This method enhances the accuracy of membrane state assessment in filtration systems.

As far as environmental conditions are concerned, performance is highly dependent on variations in certain parameters, such as temperature or the concentration of water entering the system. Here again, current prediction systems have difficulty distinguishing between the causes of reduced performance due to temperature variations caused by the effects of seasonality, or due to membrane ageing.

Moreover, membrane ageing depends not only on operating configuration and environmental parameters, but also on intrinsic properties. Each membrane has physical properties that ensure specific performance under given conditions. New membranes installed after the replacement of old ones may not have the same intrinsic properties, due, for example, to a change of membrane supplier or the introduction of a new generation of membranes. These changes can affect predictive models based on manufacturer data. Current systems therefore find the models used limited when a membrane type or even a complete operating stage is changed.

Finally, the operating configuration itself can affect performance, depending on the size of the system, the number of processing stages, concentrate routing and reprocessing circuits, the system's desired conversion rate, and so on.

One difficulty in predicting the ageing of a system such as a membrane assembly, or a plurality of stages made up of different membrane assemblies, arises from the great heterogeneity of the components influencing membrane service life, and hence the multifactorial causes of these components. In fact, the intrinsic properties of the membranes, the quality of the water, the temperature, the operating time of the membranes and the operating configuration, including cleaning during the life cycle of the membranes, are all parameters that influence membrane service life in different ways.

As a result, current prediction systems find their reliability limited by the need to reconfigure the drive model when certain operating configurations or hardware changes are made. Indeed, the specifications of membranes replacing old ones are not always described in a homogeneous way, and require tests and measurements to reconfigure the prediction model.

One aim of the inventive concepts is to overcome the aforementioned drawbacks. In particular, the inventive concepts aim to propose a method for predicting membrane replacement dates that is automatic and does not require the prediction model to depend on the hardware configuration or physical properties of the equipment used.

In order to resolve persistent problems in prior art modeling, the method of the inventive concepts aim to standardize certain indicators for predicting membrane replacement and/or cleaning dates independently of operational or environmental conditions.

### SUMMARY

According to one aspect of the inventive concepts relates to a method for the automated processing of data characterizing the state of a plurality of membranes for the filtration of a volume of liquid, said method comprising, receiving a first set of data from state sensors arranged within or near a first set of membranes, said set of membranes receiving an incoming water flow and generating a first outgoing water flow, called permeate, and a second outgoing water flow, called concentrate, said first set of data relating to external physical parameters, said data acquisitions being performed according to a plurality of first time series of data emitted by each sensor at predefined frequencies; determining at least one operating indicator for the first set of membranes, said operating indicator defining a second time series of calculated or estimated data; recording of first and second time series of data over a given acquisition time, each time series of data defining a point cloud; generating an intermediate operating indicator defining a point cloud corresponding to values of the operating indicator for which the first set of membranes is considered new and/or clean and/or cleaned, said values of the intermediate operating indicator being produced by the application of a learned normalization model; generating a normalized operating indicator characterizing the state of a plurality of membranes for the filtration of a volume of liquid, said state characterizing the fouling and/or aging of the state of the membranes independently of variations in environmental conditions, said normalized indicator defining a third time series obtained from the operating indicator and the intermediate operating indicator.

One advantage is that a normalized indicator may be generated, providing an indication of the state of membranes in terms of ageing and clogging, independently of any a priori knowledge of their physical properties. Lastly, the indicator is independent of variations in environmental parameters. Such an indicator makes it possible to monitor changes in membrane condition and anticipate maintenance operations at the right moment.

In one embodiment, the intermediate operating indicator values are produced by applying a learned normalization model and the operating indicator values.

The values of the operating indicator for which the first set of membranes is considered new and/or clean and/or cleaned may be values calculated from a function or measured from the sensors, or values corrected by the learned normalization model. In the latter case, new operating indicator values are generated to produce the intermediate operating indicator.

According to one embodiment, the normalization model is learned for each operating indicator by means of a regression on the data of the second time series relating to the operating indicator according to at least a first predefined external physical parameter from the first time series, said regression being configured over a smoothing duration to determine a set of values corresponding substantially to within a factor of minima or maxima of the values of the second time series, said determined values corresponding to a configuration of new and/or clean and/or cleaned membrane(s).

According to one embodiment, the normalization model is learned for each operating indicator from a set of driving data for said operating indicator over a smoothing duration comprising at least one maintenance and/or replacement operation on said first set of membranes.

In one embodiment, the drive data does not include data characterizing the physical properties of the membranes.

According to one embodiment, the determination of the operating indicator comprises the determination of a first operating indicator defining a differential pressure between the inlet and an outlet of the membrane assembly and represented in the form of a second time series of calculated or estimated data, the external physical parameters considered comprising at least one flow rate measurement and one temperature measurement, said external physical parameters being used to calculate the intermediate indicator values of the first operating indicator from the regression performed on the differential pressure values.

According to one embodiment, the determination of the operating indicator comprises the determination of a second operating indicator defining a pressure of the flow entering the first set of membranes and represented in the form of a second time series of calculated or estimated data, the external physical parameters considered comprising at least one temperature measurement, a measurement of the concentration of the flow entering the first set of membranes, the flow rate of the permeate flow and the flow rate of the concentrate flow of the first set of membranes, said external physical parameters being used to calculate the values of the intermediate indicator of the second operating indicator from the regression performed on the values of the pressure of the flow entering the first set of membranes.

According to one embodiment, the determination of the operating indicator comprises the determination of a third operating indicator defining a permeate flow rate at the outlet of the first membrane assembly and represented in the form of a second time series of calculated or estimated data, the external physical parameters considered comprising at least one temperature measurement, a measurement of the concentration of the flow entering the first set of membranes, the flow rate of the permeate flow and the flow rate of the concentrate flow from the first set of membranes, said external physical parameters being used to calculate the values of the intermediate indicator of the third operating indicator from the regression performed on the values of the flow rate of the permeate flow leaving the first set of membranes.

According to one embodiment, the determination of the operating indicator comprises the determination of a fourth operating indicator defining a salt passage in the permeate leaving the first membrane assembly and represented in the form of a second time series of calculated or estimated data, the external physical parameters considered comprising at least one temperature measurement, a measurement of the concentration of the flow entering the first set of membranes, the flow rate of the permeate flow and the flow rate of the concentrate flow from the first set of membranes, said external physical parameters being used to calculate the values of the intermediate indicator of the fourth operating indicator from the regression performed on the values of the salt passage in the permeate leaving the first set of membranes.

According to one embodiment, the first set of data relates to external physical parameters comprising, a measurement of inflow, permeate flow and/or concentrate flow; and/or a measurement of the conductivity of a volume of water and/or; a measurement of total organic carbon; and/or a target value corresponding to a conversion rate of the feed water volume into a treated water volume; and/or a characteristic value of the incoming flow, also called “permeation flow”; and/or a characteristic value for the membrane's water permeability.

According to an embodiment, the third time series corresponds to the time series obtained by subtracting the time series corresponding to the corrected values produced by the learned normalization model from the second time series; and/or to the time series obtained by subtracting the time series corresponding to the corrected values produced by the learned normalization model from the second time series and to which has been added a reference component corresponding to a time series of the operating indicator corresponding to a new and/or clean and/or cleaned state of the membranes, said component being calculated under average or standard environmental conditions.

According to one embodiment, the regression on the operating indicator is performed according to a plurality of external physical parameters on which the operating indicator depends.

In one embodiment, regression is implemented by means of a first learning function comprising a machine learning model with parameters learned through the implementation of a loss function.

According to one embodiment, the regression is an expectile regression, the regression being performed from an expectile loss function and an error function between the operating indicator value and a value estimated by the regression model for operating indicator values considered within a given expectile of the operating indicator value distribution. One advantage is that it is possible to determine the values of the operating indicator for which the state of the membranes is either new, clean or cleaned.

According to one embodiment, the regression is performed on the data of the second data series of the operating indicator according to a plurality of predefined external physical parameters of a plurality of first time series obtained by a plurality of sensors, said regression being performed on the basis of a generalized additive model modeling functions whose parameters are sought to be optimized by means of an expectation loss function between the calculated operating indicator value and the estimated operating indicator value within the range of predefined expectation values and for given external physical parameter values, said regression further modeling an error function and said regression being run over a so-called smoothing duration, said regression generating a set of values of a point cloud defining the intermediate indicator, said set of values corresponding to a new and/or clean and/or cleaned state of the first set of membranes.

According to one embodiment, the smoothing duration is determined so as to include a plurality of event markers relating to the maintenance of the membrane assemblies, said smoothing duration being less than the acquisition duration.

According to one embodiment, the method comprises time-stamping of events relating to the maintenance of membrane assemblies, said events corresponding to cleaning and/or replacement, each time-stamping being carried out according to a time reference marked within the acquisition duration. One advantage is that maintenance operations may be taken into account in the training of learning functions.

According to one embodiment, the method comprises the generation of values of a predicted operating indicator by applying a second learning function trained from the values of the normalized operating indicator corresponding to the third time series considered over a prediction duration, said second learning function generating predicted data on the evolution of the normalized indicator. One advantage is to anticipate maintenance operations aimed at cleaning the membranes.

According to one embodiment, the method comprises a prediction of a set of values for each normalized indicator, the training data being selected between the last two event timestamps associated respectively with two successive cleanings, a new training of the second learning function being triggered after each new event associated with a cleaning. One advantage is to create a training data set unaffected by maintenance operations in order to obtain only the evolution linked to the state of the membranes.

According to one embodiment, the method comprises a comparison of at least one predicted value of a normalized indicator with at least one predefined threshold, said comparison enabling a cleaning date to be generated. One advantage is that alerts may be generated for operators.

In one embodiment, the predefined threshold is a variable threshold whose value is generated by the execution of a function dependent on predefined parameters.

According to an embodiment, the second learning function is a function implementing a second generalized additive model.

According to one embodiment, the method comprises calculating an aging index for a set of membranes using a third learning function, said third learning function comprising a set of training data including the values extracted from the first set of data used to estimate the indicator in question, the training data being selected over the acquisition period and taking into account the timestamps of events occurring during the acquisition period. Analysis of the ageing index is used to determine a membrane replacement date.

In one embodiment, the third learning function is a recurrent neural network with a regression function based on an autoregressive method.

According to another aspect, the inventive concepts relates to a data processing system comprising a computer, a memory, a clock and a communication interface for receiving data in the form of a time series, said data processing system comprising a communication interface for transmitting the data to a server, said data processing system comprising the server for performing steps for calculating a normalized operating indicator according to the method of the inventive concepts.

In one embodiment, the system comprises a display for generating a real-time representation of at least one normalized indicator. An advantage of this is that the evolution of the normalized indicator may be followed in real time.

According to another aspect, the inventive concepts relates to a system for the treatment of a volume of feed water into a volume of filter-treated water by means of a plurality of membrane assemblies, said water treatment system comprising a water inlet for receiving a flow of water entering at least one given membrane assembly, a first filtered water outlet, called permeate, and a second residual water outlet, called concentrate, said water treatment system further comprising a set of external parameter state sensors including a water temperature sensor and at least one pressure sensor, said water treatment system comprising a data processing system of the inventive concepts.

In one embodiment, the system for treating a volume of feed water comprises a plurality of membranes organized in a plurality of membrane assemblies, each membrane assembly defining a stage for treating an input volume of water and generating an output stream. One advantage is that it is possible to configure normalized indicator control for sub-assemblies of a system. In one embodiment, the system comprises a composite indicator comprising different components relating to different normalized operating indicators of these different sub-assemblies.

In one embodiment, the system for treating a volume of feed water comprises at least one second set of membranes arranged at the outlet of the first set of membranes, with the concentrate from the first set of membranes defining the inlet to the second set of membranes.

In one embodiment, the system for treating a volume of feed water comprises at least one third membrane assembly arranged in parallel with the first membrane assembly, the concentrate from the first membrane assembly and the third membrane assembly defining the inlet to the second membrane assembly.

According to one embodiment, the first learning function comprises the implementation of a first generalized additive model taking into account the third time series exposed according to a plurality of predefined external physical parameters.

According to one embodiment, the smoothing duration is chosen to correspond to a maximum value of an aging indicator of at least one membrane or a time specific to its lifetime.

According to an embodiment, the estimation of the first operating indicator of the first set of membranes results, at least one calculation based on data from the first data set; at least one measurement from sensors located near the membrane assembly.

According to one embodiment, the normalized indicators further comprises, a normalized indicator characteristic of the feed or output flow; and/or a normalized indicator characteristic of the conductivity of a volume of water at the inlet and/or outlet of the first set of membranes; and/or a normalized indicator relating to a measurement of the salt passage between the inlet and an outlet of the first set of membranes; and/or a normalized indicator characteristic of supply pressure.

According to an embodiment, the normalized indicator characteristic of the feed flow to at least a first set of membranes comprises, a specific feed flow parameter representing the volume of water entering the first membrane assembly considered per unit time and unit membrane area when pressure is applied to said volume of water; and/or a parameter relating to a first output flow representing the volume of water filtered at the outlet, called permeate, of the first membrane assembly considered per unit of time and unit of membrane surface area when a pressure is applied to said volume of water at the inlet; and/or a parameter relating to a second output flow representing the volume of residual water, called concentrate, at the outlet of the first set of membranes considered per unit of time and unit of membrane surface area when a pressure is applied to said volume of water at the inlet; and/or a parameter relating to the inlet feed pressure to the diaphragm assembly.

According to an embodiment, the normalized indicator characteristic of the conductivity of a volume of water entering or leaving at least a first set of membranes comprises, a parameter relating to the conductivity of the permeate leaving the first set of membranes; a parameter relating to a permeability coefficient of the first set of membranes; and a parameter relating to a measurement of the conductivity difference of a volume of water at the inlet and outlet of the first set of membranes.

According to one embodiment, the method comprises suppression of raw data from at least one sensor when the acquired values are below a predefined threshold.

According to an embodiment, a first pre-training of the first learning function is carried out on the basis of a set of training data and a corrective parameter for seasonality or temperature thresholds, and a second training of the first learning function is carried out when defining the membrane assemblies, the number of membrane assemblies and the operating parameters during the smoothing duration.

### BRIEF DESCRIPTION OF THE FIGURES

Further features and advantages of the inventive concepts will become apparent from the following detailed description, with reference to the appended figures, which illustrate:

FIG. 1: A diagram showing the various stages of a method of the inventive concepts;

FIG. 2: An example of a representation of membrane fouling in a system with a series of successive cleanings, showing the effect of long-term membrane aging;

FIG. 3: An example of a system of the inventive concepts comprising a plurality of sensors and data processing means for generating normalized indicators according to the method of the inventive concepts;

FIG. 4: An example of a set of membranes modeling a stage treating an incoming flow and generating two outgoing flows including permeate and concentrate;

FIG. 5: An example of a water treatment system according to the inventive concepts comprising a plurality of treatment stages in which different membrane assemblies are implemented;

FIG. 6: An example of an evolution of an operating indicator of a set of membranes representing a first evolution curve of the differential pressure of a set of membranes in which the effects of seasonality and the evolution trend of ageing are noted;

FIG. 7: A representation of the operating indicator, here the differential pressure, according to an expectile diagram making it possible to represent the said operating indicator according to a physical parameter, here the temperature; note the curve representing the envelope of the minimum values of the diagram making it possible to generate a set of corrective values used in the method of the inventive concepts;

FIG. 8: A representation of a second curve showing the evolution of the corrected operating indicator of the set of membranes considered when the latter are in a substantially clean state;

FIG. 9: A representation of the difference between the two curves shown in FIG. 9, to which a reference curve is added to display a corrected operating indicator that is independent of operating and environmental conditions, and in particular restores the effects of aging of the membrane assembly over time.

### DETAILED DESCRIPTION

The present disclosure can be understood more readily by reference to the instant detailed description, examples, and claims. The present disclosure is not limited to the example embodiments and/or methods disclosed herein, which may, of course, vary. It is also to be understood that the terminology used herein is for the purpose of describing particular embodiments only and is not intended to be limiting. Unless defined otherwise, all technical and scientific terms used herein have the same meaning as commonly understood by one of ordinary skill in the art.

In the remainder of this description, the “data processing system” is referred to as a system comprising the means required to carry out the method steps, i.e. at least a computer and a memory. However, according to a preferred mode, the system comprises, a local software means co-located in the processing plant to perform processing on data acquired from sensors, this may be a computer configured to be a local server; and remote means such as at least one remote data server for executing method steps leading to the generation of normalized indicators and predicted plant intervention dates.

In the following, we refer to the “plant” or “water treatment system” as the set of physical means for treating a volume of water and measuring operating or environmental parameters. The plant comprises at least one dense spiral membrane assembly used, for example, for reverse osmosis applications. A set of membranes is used to treat a volume of incoming water conveyed by means of a water inlet and generating at least two streams called “permeate” and “concentrate” conveyed by means of water outlets. Typically, a water treatment system comprises sensors and hydraulic means and the data processing system. Depending on the configuration, the hydraulic means comprise valves, such as balancing valves, shut-off or shut-off valves, control valves, possibly turbines or microturbines or any other equipment for controlling, regulating and routing fluid flows such as water. The water treatment system also includes hydraulic equipment such as pumps, tanks, containers, filters, pipes and any other equipment required to operate the plant.

The water treatment plant or system may comprise one or more filtration passes for treating the incoming water volume and may comprise one or more stages defining an arrangement of membrane assemblies installed in series or in parallel having a conversion rate for treating an incoming water volume. Typically, one stage treats between 40% and 50% of the pumped water volume. To increase the portion of water treated, it is possible to install several stages in series to achieve conversion rates of 75% to 85%.

A filtration pass is a filtration treatment of a volume of water at a given characteristic operating pressure. In water desalination systems, at least two filtration passes are usually performed.

In the remainder of this description, we refer to concentration as the concentration of salts in the fluid, i.e. all the minerals present in a volume of water, for example. When measuring the salinity of a volume of water, concentration measurements or calculations may be obtained by measuring the conductivity of the volume of fluid in question. In the following description, conductivity is a measure of a fluid's conductivity, reflecting the presence of conductive elements in that fluid.

It is possible to obtain the concentration from a fluid's conductivity measurement because they correspond to equivalent quantities. Concentration and conductivity measure physical properties of a fluid that are equivalent. One of the quantities may be obtained from a measurement of the other quantity in a simple ratio, such as a coefficient or constant. To this end, a constant characterizing water quality, such as surface water or seawater or tap water, may be used to convert a conductivity measurement into a concentration value. Furthermore, when a parameter influences conductivity, such as temperature, this influence may be compensated for using a model, such as a linear model, to deduce the concentration.

FIG. 5 shows an example of an architecture comprising different stages ET₁, ET₂ and ET₃, using a plurality of membrane assemblies ENS₁₁, ENS₁₂, ENS₂ and ENS₃ arranged in different configurations, either in parallel or in series, depending on the stage to which they belong. In this example, 3 stages are in series, and the first stage comprises two sets of membranes in parallel. At each membrane assembly outlet, the concentrate flows Qc1, Qc2 are re-injected into the next stage. Permeate flows Qp1, Qp2, Qp3 may be routed to other treatment stages or operated directly.

Sensors may be used to measure environmental data such as water temperature, water pressure, water volume salinity or any other water volume quality parameter. Other sensors may be used to measure physical plant parameters, such as equipment consumption levels, incoming or outgoing flow, pressure difference, or event detection sensors.

In the remainder of this description, we refer to a plant stage as a plant subassembly comprising at least one membrane assembly with one connection or channel for receiving an incoming flow of water to be treated, and two outlet connections or channels generating two outlet flows: the permeate, corresponding to the treated flow with a salinity lower than the salinity of the incoming flow, and the concentrate, corresponding to a water flow with a salinity at least equal to the incoming water flow.

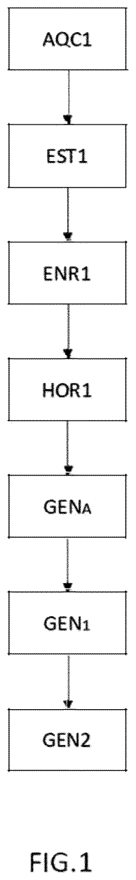

FIG. 1 illustrates the main stages of the method of the inventive concepts. A first step comprises the acquisition ACQ₁ of a set of data from various sensors 20, 21, 22 shown in FIG. 3, according to an example of a water treatment system architecture enabling the method of the inventive concepts to be implemented.

The sensors are preferably arranged within the water treatment system or close to the water treatment system so as to measure the environmental conditions to which the membranes are subjected as close as possible to the membranes.

According to one embodiment, the data processing system of the inventive concepts comprises software means such as a computer and a memory for executing a computer program implementing the steps of the method of the inventive concepts. The computer program(s) comprise(s) software instructions which, when executed, enable the steps of the method of the inventive concepts to be implemented.

### Exemplary Applications

According to a first exemplary application, the method of the inventive concepts relates to the field of reverse osmosis for the filtration of a volume of water. The method relates both to the field of membranes used for reverse osmosis in the context of filtration of the salt content of a volume of water and to so-called low-pressure reverse osmosis for uses other than desalination of a volume of water.

The method of the inventive concepts are particularly suitable for generating normalized indicators for organic membranes, i.e. those made from an organic polymer such as polyamide, known as spiral-wound “dense membranes”. These membranes are used in particular for reverse osmosis or nanofiltration applications. However, the inventive concepts is not limited to dense membranes.

According to a second exemplary application, the method of the inventive concepts relates to the field of membrane nanofiltration. In this case, the process applies to membranes configured to separate molecules in a volume of a liquid, such as water or blood.

According to a third exemplary application, the method of the inventive concepts relates to the field of membrane ultrafiltration carried out using dense membranes.

In the remainder of the description, the inventive concepts will be described with regard to the application of reverse osmosis. However, the method of the inventive concepts relates to any other field involving the use of membranes to separate particles or elements from a volume of a liquid.

### Exemplary Modeling

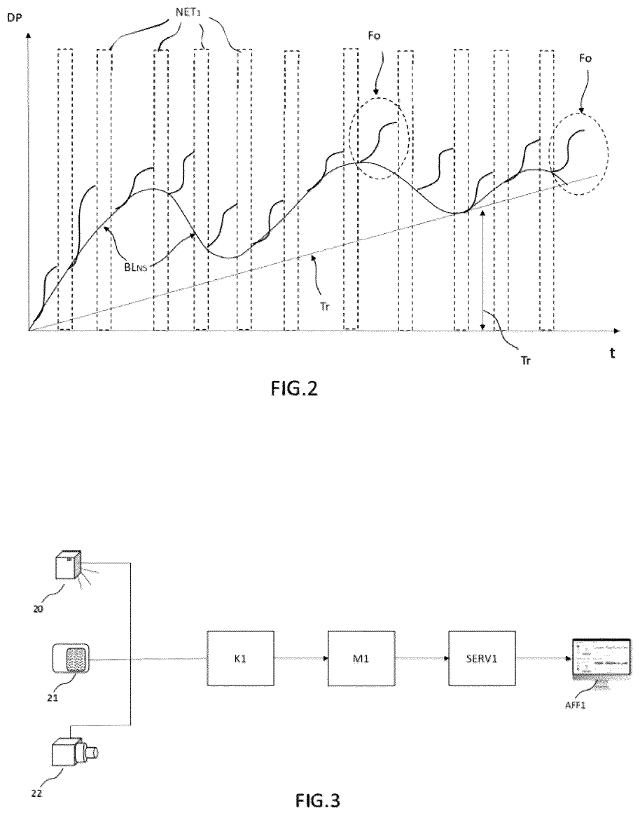

FIG. 2 shows a schematic example of the causes affecting the evolution of the state of one or more membranes. For this purpose, the evolution of a characteristic indicator is shown on the diagram, namely the differential pressure DP. The figure illustrates the various causes of changes in this indicator, including, the fouling of these membranes noted Fo and the maintenance operations aimed at cleaning them here represented by NET₁ cleaning operations; the intrinsic ageing of the membrane, degrading its physical properties over the long term, represented here by the line marked Tr and designating an ageing trend, and, finally, influences linked to external physical parameters, including operational components linked to plant architecture, operating variables, and environmental components linked to water quality and temperature, for example.

This representation provides a better understanding of the different cycles that membranes undergo and which cause fouling. One of the objectives of the inventive concept's method is to isolate some of these causes so as to better predict future maintenance operations linked to membrane fouling and replacement.

FIG. 2 shows the differential pressure of a set of membranes on the ordinate and time on the abscissa. The line marked BLNS represents the evolution of the differential pressure DP of a set of membranes as a function of external physical parameters. The lines marked Fo represent the evolution of the DP differential pressure due to membrane fouling, and the line marked Tr represents the evolution of the DP differential pressure due to membrane ageing. It is this last component in particular that enables us to establish a reliable predictive model of real membrane ageing.

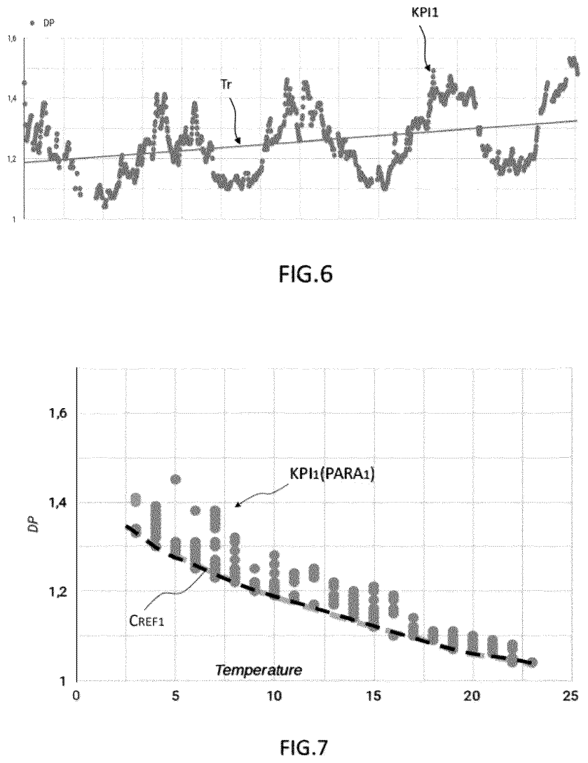

FIG. 6 shows the differential pressure values DP defining the first operating indicator KPI₁. The DP differential pressure values are recorded as raw data on a scale of several months or years. This graph allows to observe a large variation in DP over the years, due to the influence of water temperature variations over time. This influence gives a wave-like pattern to the data. However, on average, it appears that the operating indicator for differential pressure DP increases from the first to the fifth year, or even the Tr line, which indicates the tendency of the membranes to age and/or clog. This fouling trend is not visible during operation, as temperature-related variations are much greater than those due to irreversible fouling.

### Environmental Data Acquisition

The method includes a step for receiving data, denoted AQC₁ in FIG. 1, from sensors arranged in or near an installation in order to measure values of environmental parameters, so-called external physical parameters, related to an installation of a plurality of membranes treating or filtering an incident volume of water. Sensors may include, for example, temperature probes, probes such as conductivity probes, flow meters, pressure sensors, etc.

In one embodiment of the inventive concepts, the data acquired by the sensors is stored in a memory. The data is acquired and stored in the form of a time series. The data is therefore preferably time-stamped. The method of the inventive concepts relates to a first step involving the reading of the recorded data from the sensors. However, according to one embodiment, the method of the inventive concepts may include the prior step of acquiring the sensors. Insofar as the method of the inventive concepts is implemented by a computer or by a plurality of computing units, it is not necessary for the method to include the preliminary acquisition step, which may be separated from the implementation of the method of the inventive concepts, since the latter may be carried out a posteriori within a certain period of time after the acquisitions.

Recorded data on external physical parameters includes at least temperature values Tf of a volume of water entering a stage comprising a set of membranes, and pressure values Pf of this same volume of entering water. These values are measured preferably at regular intervals by at least one temperature sensor.

These values may also be measured at permeate {Tp, Pp} or concentrate {Tc, Pc} level.

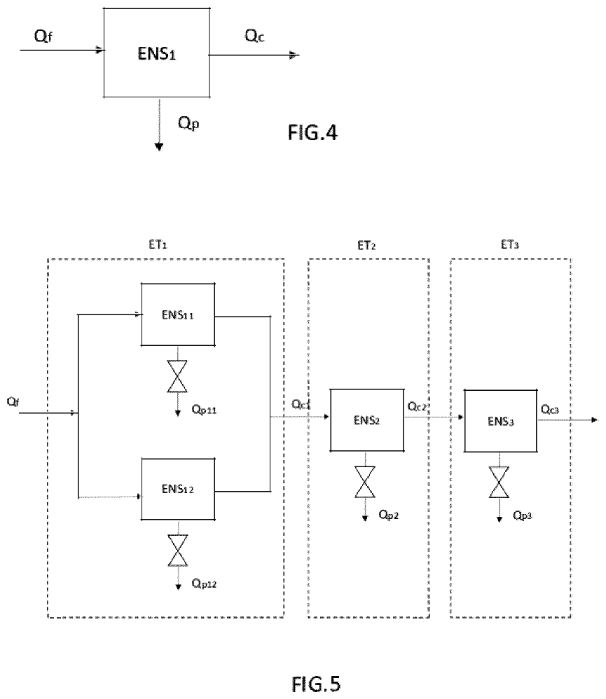

According to an example embodiment, other external physical parameter values are recorded and evaluated by the method of the inventive concepts. In particular, the values of incoming flow rate Qf and concentration Cf of the incoming volume are measured. Incoming flow is also referred to as feed flow Qf. For example, FIG. 4 shows the inlet flow rate Qf of an ENS₁ membrane assembly and the outlet flow rates Qp and Qc of the permeate and concentrate respectively.

According to one example embodiment, values of external physical parameters at the outlet of the membrane assembly are recorded and evaluated by the method of the inventive concepts. These may be values of external physical parameters of the permeate or concentrate, the physical parameters being respectively noted Tp, Qp, Cp, Pp for the permeate and Tc, Qc, Cc, Pc for the concentrate.

A general measurement of an external physical parameter Ti, Qi, Ci, Pi is noted in the following and these values may be specified according to their point of measurement with the indices f, p, c depending on whether the parameter is measured upstream of the membrane assembly or downstream at the permeate or concentrate level.

One advantage is to measure the same parameter at different measurement points and calculate certain differential values such as differential pressure DP or salt passage or retention, otherwise known as differential concentration.

It should be noted that time series may be acquired, recorded and evaluated at different frequencies and over different acquisition times. In one embodiment, the method of the inventive concepts includes any preliminary step aimed at oversampling or undersampling a time series so as to homogenize the quantities of values of each time series when they are used jointly by mathematical operations or algorithms.

Each time series comprising all the values for each external physical parameter is referred to as SERIE₁. There are therefore as many SERIE₁ time series as there are time series of external physical parameter values.

When acquisitions are made over different acquisition periods, an operation may be carried out to evaluate data over the same period.

### Determining Indicators

The method of the inventive concepts makes it possible to store measured or calculated data from the second SERIE₂ time series corresponding to the values of the KPIᵢ operating indicators over a period of time known as the DA acquisition period. In its simplest implementation, the method of the inventive concepts comprises the operation of a single operating indicator, for example the first operating indicator KPI₁. In other implementations, the method of the inventive concepts is implemented to exploit a plurality of operating indicators, for example the four operating indicators mentioned above: KPI₁, KPI₂, KPI₃, KPI₄. According to various embodiments, combinations of these indicators are exploited, for example the first and third KPI₁, KPI₃ or other combinations. A selection of operating indicators may be advantageously exploited so as to produce normalized indicators which will be used to train a learning function, i.e. a machine learning model, with the aim of predicting in the short or medium term. Indicators are selected according to plant configuration, the assumed influence of variations in environmental conditions and operating parameters. Different variants of the inventive concepts method may therefore be implemented according to plant configurations.

The various stages of the method of the inventive concepts include the use of operating indicators to achieve several objectives: define a normalization model; determine an intermediate indicator and a normalized indicator; define a prediction model; and determine a short- and/or long-term prediction to anticipate the dates of maintenance operations on the membranes.

In order to meet all these objectives, various indicators are defined as part of the inventive concepts process.

KPIᵢ: designates the operating indicator obtained with actual environmental conditions obtained during acquisition, e.g. temperature Ti, pressure Pi and flow Qi, etc.

KPIᵢ′: refers to the normalized operating indicator, an indicator that is independent of environmental conditions and that mainly reflects the state of fouling or ageing of the membrane, in order to predict maintenance operations.

KPIᵢ₀′: designates the normalized operating indicator, corresponding to an indicator calculated for reference environmental conditions, which mainly reflects the state of fouling or ageing of the membrane in order to predict maintenance operations.

KPIᵢ\hat{ }: designates the membrane operating indicator estimated by the loss function in the regression step and obtained with actual environmental conditions obtained during acquisition, e.g. temperature Ti, pressure Pi and flow Qi, etc.

KPI_{iA}: refers to the operating indicator for new or clean membranes obtained with actual environmental conditions obtained during acquisition, e.g. temperature Ti, pressure Pi and flow Qi, etc. It is also called the intermediate indicator. It is also referred to as an intermediate indicator.

KPIᵢ₀: designates the membrane operating indicator obtained with reference environmental conditions obtained with reference operating parameters, e.g. temperature T₀, pressure P₀ and flow Q₀, etc.

KPI_{iA0}: designates the operating indicator of new or clean membranes obtained with reference environmental conditions obtained with reference operating parameters, e.g. temperature T₀, pressure P₀ and flow Q₀, etc.

KPIᵢₚ₁: designates the membrane operating indicator predicted by a first prediction model trained on the normalized operating indicator, said prediction being a short-term prediction.

KPIᵢₚ₂: designates the membrane operating indicator predicted by a second prediction model trained on the normalized operating indicator, said prediction being a long-term prediction.

The method of the inventive concepts includes the determination of at least one operating indicator, noted KPIᵢ, this step is noted EST₁ in FIG. 1. This step is preferably performed by a computer which may be either a local computer K₁ shown in FIG. 1 or a computer on a remote server represented by SERV₁. A memory is shown to store the data produced during the calculation of the operating indicators KPIᵢ and the normalized operating indicators KPIᵢ′ and possibly intermediate corrected or predicted values such as the values of the reference curve operating indicator KPI_{iA} or the estimated values of the operating indicator KPIᵢ\hat{ }, or the predicted values KPIᵢₚ₁, KPIᵢₚ₂ by the normalized indicator monitoring prediction model.

Indicators may be defined according to time series defined over different acquisition periods than the first SERIE₁ time series. In this case, the SERIE₁ and SERIE₂ series may be processed over the same period. This may involve, for example, defining a common time window.

### KPI1 (DP)

According to a first example, a first operating indicator KPI₁ corresponds to the differential pressure noted DP.

This differential pressure DP results from a pressure difference between the volume entering the first membrane assembly and an outlet volume, such as the concentrate. The pressure difference could also be measured between the inlet and the permeate.

According to a first example, the differential pressure DP may be calculated from certain operating parameters measured in particular by the sensors. For this purpose, a function f₁ is available to model this differential pressure as a function of temperature and average flow rate Qn, where Qn=(Qc+Qf)/2N. Here N corresponds to the number of tubes comprising the membrane assembly, each tube forming an arrangement of a set of spiral-wound membranes. Qc is the concentrate water flow rate and Qf the incoming water flow rate. KP₁=DP=f₁(Qn, Ti).

The method of the inventive concepts includes a step enabling an operating indicator KPI₁ to be obtained from measurements of temperatures Ti and flow rates Qc and Qf.

According to other examples, other external physical parameters could be taken into account to calculate or model the influence of these parameters on the evolution of this indicator.

According to a second example, the differential pressure DP may be directly measured from at least one differential pressure sensor or a plurality of pressure sensors arranged upstream and downstream of the diaphragm assembly.

The first indicator KPI₁ may advantageously take the form of a SERIE₂ time series. In this case, each calculated or measured value of differential pressure DP is associated with a date. The date of each operating indicator value may be set equal to the date of each operating parameter value of a first SERIE₁ time series used in calculating the first operating indicator KPI₁.

When the differential pressure DP is directly measured by sensors, a common clock may be used with the one(s) used to time-stamp the other physical parameters measured, in order to maintain date consistency between the first SERIE₁ time series and the second SERIE₂ time series.

The method of the inventive concepts generates an indicator KPI_{1A} representing the equivalent differential pressure DP′, which is a reconstituted indicator corresponding to the differential pressure of the set of membranes when they are new or cleaned by a cleaning operation. This indicator is obtained for actual measurement conditions of external physical parameters. This indicator will then be used to obtain a normalized indicator KPIᵢ₀′ giving a state of the membrane for reference environmental conditions.

One objective is to calculate the values of the first indicator KPI₁ for different measurements of temperature Ti and average flow Qn in order to estimate, by means of a first learned normalization model MOD_{N1}, an evolution of the first intermediate indicator KPI_{1A}. The first normalization model MOD_{N1} is learned, for example, by means of regression. Thanks to the inventive concepts, this first intermediate indicator KPI_{1A} may then be used to calculate a first normalized indicator KPI₁′ or KPI₁₀′, which more reliably reproduces, in particular, the contribution of membrane ageing and fouling.

One advantage of this first KPIᵢ′ indicator is that it helps monitor longitudinal clogging of the membrane assembly.

The method of the inventive concepts makes it possible to define a plurality of operating indicators {KPIᵢ}_{i[1:k]} and associated normalized operating indicators {KPIᵢ′}_{i[1:k]} providing information on the state of the membranes, particularly with regard to their clogging and ageing. In order to obtain indicators that are reliable, robust and independent of environmental data, in particular seasonal effects, the method of the inventive concepts makes it possible to normalize the {KPIᵢ′}_{i[1:k]}. operating indicators.

### KPI2 (Pf)

A second indicator KPI₂ is defined by the operating parameter relating to an incident flow pressure Pf exerted on the first set of ENS₁ membranes, also known as the feed pressure Pf. The incident flow pressure Pf may be either calculated from a model and measurements of physical parameters of a model, or directly measured from at least one pressure sensor arranged at the inlet of the first set of ENS₁ membranes.

When this second indicator KPI₂ is calculated from a model, the incident flow pressure Pf may be modeled according to a function f₂ of the following environmental parameters: temperature Ti, incoming flow concentration Cf, permeate flow rate Qp and concentrate flow rate Qc of the first set of ENS₁ membranes, for example of a stage or pass of the treatment plant comprising a first set of ENS₁ membranes. According to other examples, other external physical parameters could be taken into account to calculate or model the influence of these parameters in the evolution of this indicator.

We obtain the following expression: KPI₂=Pf=f₂(Ti, Cf, Qp, Qc).

The example described cites 4 parameters selected as influencing the second indicator, but other environmental parameters may also be taken into account within the framework of this inventive concepts. The inventive concepts enables at least one parameter influencing the evolution of the second indicator to be taken into account.

The inventive concepts method therefore makes it possible to obtain a second operating indicator KPI₂ from measurements of temperature Ti, concentration Cf, permeate flow rate Qp and concentrate flow rate Qc of the first ENS₁ membrane assembly.

According to a second example, the pressure of the incoming flow Pf may be directly measured from a pressure sensor or a plurality of pressure sensors arranged upstream of the first set of ENS₁ membranes.

The second KPI₂ indicator may advantageously take the form of a second SERIE₂ time series. It should be remembered that each time series corresponding to an operating indicator is noted SERIE₂, although the time series may differ according to the indicators chosen. In this case, each calculated or measured value of incoming flow pressure Pf is associated with a date. The date of each operating indicator value may be taken to be equal to the date of each operating parameter value of a first SERIE₁ time series used in the calculation of the second operating indicator KPI₂.

Identical to the first KPI₁ indicator, when the incoming flow pressure Pf is directly measured by at least one sensor, a common clock may be used with the one used to time-stamp the other measured physical parameters in order to maintain date consistency between the first SERIE₁ time series and the second SERIE₂ time series.

The method of the inventive concepts generates an intermediate indicator KPI_{2A}′ representing the equivalent inflow pressure Pf′, which is a reconstituted indicator whose value corresponds to the inflow pressure into the membrane assembly when it is new or clean, or cleaned by a cleaning operation.

One objective is to calculate the values of the second operating indicator KPI₂ for different measurements of external physical parameters, in order to estimate by a second learned normalization model MOD_{N2} an evolution of an intermediate indicator KPI_{2A}. The second normalization model MOD_{N2} is learned by regression, for example. This intermediate indicator KPI_{2A} may then be used to calculate a normalized indicator KPI₂′ or KPI₂₀′, which more reliably reproduces the contribution of membrane ageing and fouling.

One advantage of this second KPI₂ is that it contributes to monitoring the energy consumption of all ENS₁ membranes.

### KPI3 (Permeate Flow Rate)

A third KPI₃ is defined by the operating parameter relating to a permeate flow rate Qp at the outlet of the first set of ENS₁ membranes. The permeate flow rate Qp may be either calculated from a model and measurements of physical parameters of the model, or directly measured from a sensor arranged at the permeate outlet of the first set of ENS₁ membranes.

This indicator may also be represented by the specific flux SP. It represents the volume of water produced per unit of time and per unit of membrane surface area when a given pressure is applied to the feed water. It is an indicator of the membrane's capacity to produce a given volume of output water. As the membrane ages or degrades, the SP specific flux tends to decrease. The decrease in SP is an indicator of fouling or deterioration of the membrane material. However, this indicator, like that corresponding to permeate flow rate Qp, is also influenced by temperature, water salinity and water temperature. According to other examples, other external physical parameters could be taken into account as factors influencing the evolution of this indicator.

When this third KPI₃ indicator is calculated from a model, the permeate flow rate Qp may be modeled according to a function f₃ of the following environmental parameters: temperature Ti, incoming flow concentration Cf, permeate flow rate Qp and concentrate flow rate Qc of the first set of ENS₁ membranes, for example of a stage or pass of the treatment plant comprising a first set of ENS₁ membranes. According to another embodiment, other external physical variables may be taken into account in the KPI₃ modeling.

We obtain the following expression: KPI₃=Qp=f₃(Ti, Cf, Qp, Qc).

The example described cites 4 parameters selected as influencing the third indicator, but other environmental parameters may also be taken into account within the framework of this inventive concepts. The inventive concepts makes it possible to take into account at least one parameter that influences the evolution of the third indicator.

The method of the inventive concepts thus makes it possible to obtain a third operating indicator KPI₃ from measurements of temperatures Ti, the concentration of the incoming flow Cf, the flow rate of the permeate flow Qp and the flow rate of the concentrate flow Qc of the first set of ENS₁ membranes.

According to a second example, the permeate flow rate Qp may be directly measured from at least one sensor of a device arranged downstream of the first set of ENS₁ membranes.

The third indicator KPI₃ may advantageously take the form of a second time series SERIE₂. In this case, each calculated or measured value of the permeate flow rate Qp is associated with a date. The date of each value of the third operating indicator KPI₃ may be taken equal to the date of each operating parameter value of a first time series SERIE₁ used in the calculation of the third operating indicator KPI₃.

Identically to the first and second KPI₁, KPI₂ indicators, when the permeate flow rate Qp is directly measured by at least one sensor, a common clock may be used with the one used to time-stamp the other measured physical parameters in order to maintain date consistency between the first SERIE₁ time series and the second SERIE₂ time series.

The method generates a third intermediate indicator KPI_{3A}′ representing the permeate flow rate Qp equivalent Qp′, which is a reconstituted indicator whose value corresponds to the permeate flow Qp entering the membrane assembly when it is new or clean, or cleaned by a cleaning operation.

One objective is to calculate the values of the third operating indicator KPI₃ for different measurements of external physical parameters in order to estimate by a third learned normalization model MOD_{N3} an evolution of an intermediate indicator KPI_{3A}. The third normalization model MOD_{N3} is learned by regression, for example. This intermediate indicator KPI_{3A} is then used to calculate a normalized indicator KPI₃′ or KPI₃₀′, which more reliably reproduces the contribution of membrane ageing and fouling.

One advantage of this third KPI₃, possibly in combination with other data, is that it contributes to monitoring transmembrane clogging of the ENS₁ membrane assembly.

### KPI4 (Salt Passage)

A fourth operating indicator KPI₄ is defined by the operating parameter relating to salt passage SP, expressed as a percentage of salt filtered into the concentrate SPc or residual in the permeate SPp at the outlet of the first set of ENS₁ membranes. Salt passage may be expressed, for example, as a concentration ratio between inlet and outlet. In this example, we consider the salt passage in permeate SPp. The salt passage SPp may either be calculated from a model and measurements of the model's physical parameters, or directly measured from a sensor arranged at the permeate outlet of the first ENS₁ membrane assembly. This indicator may also be represented by the conductivity of the permeate.

According to other examples, other external physical parameters could be taken into account to calculate or model the influence of these environmental parameters on the evolution of this indicator.

When this fourth indicator KPI₄ is calculated from a model, the salt passage in the permeate SPp may be modeled according to a function f₄ of the following environmental parameters: temperature Ti, incoming flow concentration Cf, permeate flow rate Qp and concentrate flow rate Qc of the first set of ENS₁ membranes, for example of a stage or pass of the treatment plant comprising a first set of ENS₁ membranes.

We obtain the following expression: KPI₄=SPp=f₄(Ti, Cf, Qp, Qc).

The example described cites 4 parameters selected as influencing the fourth indicator, but other environmental parameters may also be taken into account within the framework of this inventive concepts. The inventive concepts makes it possible to take into account at least one parameter that influences the evolution of the fourth indicator.

The method of the inventive concepts therefore makes it possible to obtain a fourth operating indicator KPI₄ from the measurements of temperature Ti, incoming flow concentration Cf, permeate flow rate Qp and concentrate flow rate Qc of the first set of ENS₁ membranes.

According to a second example, the salt passage in the permeate SPp may be directly measured from at least one sensor or device arranged downstream of the first ENS₁ membrane assembly.

The fourth indicator KPI₄ may advantageously take the form of a second time series SERIE₂. In this case, each calculated or measured value of salt passage in the permeate SPp is associated with a date. The date of each value of the fourth operating indicator KPI₄ may be taken equal to the date of each operating parameter value of a first time series SERIE₁ used in the calculation of the fourth operating indicator KPI₄.

Identically to the first, second and third indicators KPI₁, KPI₂, KPI₃, when the salt passage in the permeate SPp is directly measured by at least one sensor or device, a common clock may be used with the one used to time-stamp the other measured physical parameters in order to maintain date consistency between the first SERIE₁ time series and the second SERIE₂ time series.

The method of the inventive concepts generates a fourth intermediate indicator KPI_{4A}′ representing the salt passage in the equivalent permeate SPp′, which is a reconstituted indicator whose value corresponds to the salt passage Sp obtained by the set of membranes when they are new or clean or cleaned by a cleaning operation.

One objective is to calculate the values of the fourth operating indicator KPI₄ for different measurements of external physical parameters in order to estimate by a fourth learned normalization model MOD_{N4} an evolution of an intermediate indicator KPI_{4A}. The fourth normalization model MOD_{N4} is learned by regression, for example. This intermediate indicator KPI_{4A} is then used to calculate a normalized indicator KPI₄′ or KPI₄₀′, which more reliably reproduces the contribution of membrane ageing and fouling.

One advantage of this fourth KPI₄ is that it contributes to monitoring the quality of drinking water produced by all ENS₁ membranes.

Other operating indicators may be used, in particular the fourth indicator may be replaced by a substantially equivalent one, namely the permeate concentration Cp.

Measured data from the first SERIE₁ time series and the second SERIE₂ time series are stored in a system memory. This step is labelled ENR₁ in FIG. 1.

Other examples of indicators may be implemented. According to one example, a fifth operating indicator KPIs corresponds to the concentration of the permeate or concentrate. This latter indicator may be a function of temperature Ti and differential pressure DP.

### Normalization

Normalization comprises two steps: a first step consists in automatically defining the normalization function or normalization model, MOD_{Ni}, by means of a learning algorithm, from a history of new, clean or cleaned membrane data, and a second step consists in applying the learned normalization model MOD_{Ni} to actual recorded data to generate an intermediate indicator KPI_{iA} and a normalized indicator KPIᵢ′ or KPIᵢ₀′. This last step is denoted GENA in FIG. 1.

A first learning method is used to create a MOD_{Ni} normalization model to generate a normalized indicator for predicting membrane replacement and/or cleaning. In this case, the aim is to obtain an aging indicator. In this case, the training data are preferably selected at the beginning of the life cycle of a membrane or a set of membranes. The aim is to train the normalization model over the first few weeks, months or even years of operation of a membrane or membrane assembly.

This learning method may be used to generate an indicator that gives an indication of aging and also of clogging, and therefore an indicator of clogging or fouling of a set of membranes.

A second learning method is used to create a MOD_{Ni} normalization model to generate a normalized indicator for predicting membrane replacements in particular. In this case, the aim is to obtain a clogging indicator. In this case, the training data are not necessarily selected from the first phase of the life cycle of a membrane or a set of membranes. In one embodiment, the aim is to train the normalization model over periods comprising several maintenance operations, such as cleaning a membrane or a set of membranes.

This second teach-in generates an indicator that gives an indication of the clogging or fouling of a set of membranes, independently of their replacement.

Normalization includes modeling of indicators according to operational environmental conditions or reference environmental conditions, and according to the state of the membranes, depending on whether they are considered in their operational state or in their new, clean or cleaned state.

The following relationships are noted:
KPIᵢ=KPI_{iA}+TC with TC a corrective term related to wear, aging and fouling of the membranes and KPI_{iA} the term representing the operating indicator when the membranes are new and/or clean and/or cleaned taken from the normalization model.

This equality remains true under reference conditions, so we obtain:

$${KPI}_{i 0} = {KPI}_{iA 0} + TC$$

Note at this point that an initial KPIᵢ′ normalization may be written with the TC term, which provides an indicator of aging or clogging.

$$TC = {KPI}_{i}^{′} = {KPI}_{i} - {KPI}_{iA}$$

Note that a corrective term adjusted by the adjournment of a term calculated under reference conditions generates a normalized indicator within orders of magnitude identical to the KPIᵢ indicator:

$${TC}_{0} = {KPI}_{i 0}^{′} = {KPI}_{i A 0} + ( {KPI}_{i} - {KPI}_{i A} )$$

In another example, a further KPI_{iA0} component may be added. The addition of a constant may also be achieved in another way.

### Learning the Normalization Function, Regression

In order to calculate the KPI_{iA} values when the membranes are new and/or clean and/or cleaned, the inventive concepts involves learning a learning function, also known as a normalization function or normalization model. This learning method aims to define the parameters of this model by means of regression. The inventive concepts advantageously implements a regression based on an expectation of the values of the operating indicator, considering at least one external physical parameter. The regression may be multifactorial, taking into account a plurality of external physical parameters.

The assumptions of an expectile-based loss function modeling to learn a normalization model to generate operating indicators are therefore, the existence of sufficient explanatory variables: the residual is due solely to soiling, ageing and measurement noise; the KPIi measurement points of the new and/or clean and/or cleaned membrane correspond substantially to the extreme values: in particular, the minimum values for the operating indicators: DP, Cp, Pf and the maximum values for the specific flux Sf; In this case, “appreciably” means the measurement points to within one factor in the expectile of the distribution, particularly when several external physical parameters influence the indicator values; and the difference between the measured KPI and the modeled KPI does not depend on the explanatory variables.

In order to normalize these indicators, the method includes a step aimed at calculating a point cloud of corrected values of the selected operating indicators KPIᵢ to generate an intermediate operating indicator KPI_{iA}. The aim of normalization is to produce a normalized indicator or normalized indicators representative of wear or fouling independently of variations in external physical parameters. In other words, the method of the inventive concepts seeks to produce a normalized indicator KPIᵢ′ or KPIᵢ₀′ that is not sensitive to variations in environmental conditions such as water temperature or salt concentration of the volume of water entering the first ENS₁ membrane assembly, or physical operating parameters such as inflows, permeate and concentrate flow rates, or permeate pressures.

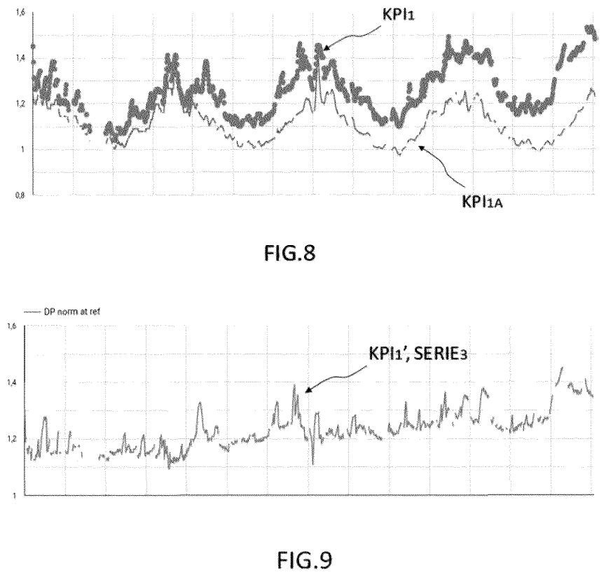

In order to standardize the operating indicators, the first step is to calculate an intermediate operating indicator KPI_{iA}. This intermediate indicator is represented by a reference curve C_{REF1}. This reference curve C_{REF1} comprises all the points of the new point cloud produced by the MOD_{Ni} normalization model. This point cloud may be represented on FIG. 7 in the expectile diagram, here represented with a single external physical parameter, temperature, or as a second intermediate time series SERIE_{2A} on FIG. 8. This intermediate time series is denoted SERIE_{2A}, and consists of the points of the reference curve C_{REF} used to obtain this curve. The first KPI₁ is associated with a first reference curve C_{REF1}, the second KPI₂ is associated with a second reference curve C_{REF2}, the third KPI₃ is associated with a third reference curve C_{REF3}, the fourth KPI₄ is associated with a fourth reference curve C_{REIF4}. Generally speaking, we speak of a reference curve C_{REFi} for each KPIᵢ operating indicator.

### Regression

The reference curve C_{REF} or the second intermediate time series SERIE_{2A} is obtained thanks to an intermediate indicator obtained thanks to the application of a normalization model, said model being generated thanks to a regression operation. The regression operation consists in obtaining values of a parameterization of a normalization model for a second SERIE₂ time series of an operating indicator KPIᵢ by considering the influence of a set of external physical parameters considered said operating indicator. Each intermediate operating indicator is produced by applying its own normalization model trained according to a given regression. To this end, we consider the influences of the external physical parameters used in the modeling of each external indicator, in particular in the functions f₁, f₂, f₃, f₄. Note that these functions f₁, f₂, f₃, f₄ may or may not be explicit. They reflect the influence of external physical parameters on the operating indicator under consideration. For each set of external physical parameter values PARAᵢ considered, regression enables us to select a KPIᵢ value located within a given expectile of the distribution of KPI values.

FIG. 7 shows a representation of the first KPI₁ indicator, i.e. differential pressure DP as a function of temperature Ti. This representation provides a simple illustration of the expectile function with respect to a single variable, but is not realistic in the case of two variables such as temperature Ti and average flow Qn for the first KPI₁. Another representation would be necessary in a multifactor case.

An expectation regression is used to determine a normalization function used to generate an intermediate operating indicator, which can be represented according to a reference curve C_{REF1}. However, when the regression is multi-criteria, i.e. performed by taking into account different external physical parameters PARAᵢ, it results in an envelope of values obtained by considering a representation of the KPIᵢ operating indicator in a 2-dimensional space.

Recall that an expectation is a function of the distribution of a variable Y, in this case the values of the KPIᵢ operating indicator. The expectile characterizes the distribution function of the variable.

Each KPIᵢ operating indicator is therefore represented in an N-dimensional space, each dimension being associated with an external physical parameter PARAᵢ. A regression is implemented to generate a normalization model used MOD_{Ni} to produce a point cloud. This point cloud may be represented by a lower or upper envelope of KPIᵢ values, the reference curve C_{REFi}. This lower or outer envelope, depending on the operating parameter considered KPIᵢ, corresponds to operation when the first set of ENS₁ membranes is new and the membranes are not fouled, or when the component associated with membrane fouling is/are very low, or even non-existent. The advantage of considering points on the indicator for regression purposes, where the membranes have not aged significantly, is to obtain a normalization model providing an indication of membrane ageing. When these points are identified, particularly within the lower or upper envelope, they correspond to values that are only sensitive to external parameters and no longer to membrane fouling, since in these points the membranes are assumed to be clean.

According to one example, an expectile regression may be implemented so as to retain a portion of the KPIᵢ operating indicator points corresponding to a given expectile value for given physical parameter values. In other words, for a given temperature Ti and a given average flow rate, the method may be used to retain the KPIᵢ operating indicator values by considering the predefined expectile percentage. The regression is then carried out considering that the values retained are those of the operation of a new and/or clean and/or cleaned membrane after a cleaning operation in this portion of expectile.

The method of the inventive concepts makes it possible to configure the expectile, for example, with a characteristic value of the distribution relative to 2% expectile or 4% expectile or 6% expectile, or even a higher or lower percentage of the expectile function of the operating indicator. The method of the inventive concepts makes it possible to determine an expectile regression configuration that defines a good compromise between achieving good regression accuracy with the lowest possible percentage of expectile to obtain a stable algorithm with the ability to optimize error, and a maximum number of points to achieve a regression with the ability to converge quickly. Indeed, the lower the expectile, the lower the number of points and the less accurate the regression.

In one embodiment, the function associating the observed external physical parameters with the KPI_{IA} indicator is configured on the basis of a generalized additive expectile model (GAM). The GAM functions then correspond to the set of functions that we seek to define according to an optimization criterion achieved by the loss function and error modeling during regression. In other embodiments, other functions could be implemented within the framework of the inventive concepts.

According to one embodiment, the regression is modeled on the basis of a loss function between the values of the KPIᵢ observable and the estimated value of the KPIᵢ\hat{ } operating indicator under consideration in the selected expectile percentage. This loss function is used to determine the best normalization function, i.e. the best normalization model, i.e. the parameters of the normalization model. The normalization model comprises coefficients or parameters which are calculated by regression so that the estimated operating indicator KPIᵢ\hat{ } corresponds to the measured or calculated operating indicator values KPI_{iA} within the selected expectation percentage for different values of the external physical parameters PARAᵢ. The loss function then converges an error to reduce both the estimated KPIᵢ\hat{ }and calculated KPIᵢ values.

The estimation error takes into account a differentiated weighting of overestimates and underestimates.

The loss function may be modelled as follows:

$${F}_{LOS} = \sum W ( {y}_{ob served} - {y}_{estimated} ) \cdot {( {y}_{observed} - {y}_{estimated} )}^{2} \\ \text{Where:} \\ W ( {y}_{observed} - {y}_{estimated} ) = Alpha , if ( {y}_{observed} - {y}_{estimated} ) > 0 \\ W ( {y}_{observed} - {y}_{estimated} ) = 1 - Alpha , if ( {y}_{observed} - {y}_{estimated} ) < 0$$

This is known as Alpha expectile.

Error modeling may comprise various embodiments. According to one example, error modeling comprising a least squares minimization may be implemented.

One advantage of a GAM model is that it enables regression to be performed, regardless of the number of external physical parameters. One advantage is therefore to be able to take into account a model in which a KPIᵢ operating indicator is possibly influenced by several external physical parameters, for example between 2 and 5 external physical parameters.

Another advantage of using a GAM model is that it eliminates the need for a function linking each KPIᵢ operating indicator with the external physical parameters PARAᵢ, whatever the relationship between the indicator and the external physical parameters. In fact, whether the relationships are linear or non-linear, the GAM model applies.

GAM is particularly useful for removing the effect of variations in each physical parameter value on the values of the KPIᵢ under consideration, all other things being equal, i.e. taking into account the same evolution or value of the other parameters when removing the effect of a given parameter.

When modeling a GAM model, the data produced at the output of the model includes on the one hand a parameterization of the dependencies {x, y} of each physical parameter {PARA₁, PARA₂} on the observable, i.e. the KPIᵢ operating indicator, and on the other hand a value produced from the observable, i.e. the estimated KPIᵢ\hat{ }.

In other words, the GAM model may be used to generate a model in which the KPIᵢ indicator is x-dependent on the first PARA₁ parameter and y-dependent on the second PARA₂ parameter. These factors may then be used to weight each physical parameter value considered in its dependency relationship with the KPI₁ indicator to predict a new estimated value for the KPIᵢ\hat{ } indicator. Regression then converges the error between the known values of the KPIᵢ and the estimated value of the KPIᵢ\hat{ }.

According to another example, a regression based on a quantile GAM generalized additive model may also be configured. According to another example, a logistic regression may be configured.

The regression is preferably carried out over a so-called smoothing duration DL, which takes into account data from the beginning of the membranes' lifetime.

One advantage is to obtain training values for the normalization model that are not yet affected by membrane aging. In this way, the intermediate operating indicator KPI_{iA} and the reference curve C_{REF} may be used to generate a normalized indicator KPIᵢ′ or KPIᵢ₀′, showing the evolution of membrane condition since their initial state. One advantage is that it enables the evolution of membrane degradation or clogging to be better monitored. However, in order to have a stable and convergent regression normalization model, a minimum data set is required. Thus, the period taken into consideration may range from a few days to a few years in a wide range, and from a few months to 1 year in a narrower range. These durations depend on plant size, data volume, etc.

Alternatively, the entrainment values do not necessarily focus on the beginning of the membrane life cycle, but on a portion of the life cycle comprising several maintenance operations such as cleaning. One advantage of this is that it is possible to build up a model of membrane fouling trends without having to measure aging precisely.

### Use of Learned Model Beyond Smoothing Duration

According to one example, the normalization model has been learned over the smoothing duration D_{L}. The smoothing duration D_{L} corresponds to the learning period in which the regression is used to calibrate the normalization model. In one embodiment, the cleaning period/frequency may be integrated into this training, so that the training data comprises several cleaning cycles.

The normalization model learned through regression may then be used over the entire D_{A} acquisition period and/or in real time from newly acquired data to calculate the KPI_{iA} values corresponding to the C_{REFi} reference curve representation. Each normalization model may be learned according to a given smoothing duration D_{L} depending on the KPIᵢ operating indicator under consideration. According to a preferred mode, the learning period D_{L} is the same for each constructed normalization model MOD_{Ni} associated with a given operating indicator KPIᵢ. The method therefore generates as many learned normalization models as calculated operating indicators.

The values of the normalized indicator KPIᵢ′ or KPIᵢ₀′ are then obtained by operations between the calculated operating indicator KPIᵢ and the intermediate operating indicator KPI_{iA}. According to an embodiment detailed below, the normalized operating indicators KPIᵢ′ are used to train a machine learning model, called prediction model MOD_{Pi} or MOD_{PLTi}, to predict the evolution of the normalized operating indicator KPIᵢ′ or KPIᵢ₀′ beyond the acquisition period D_{A}.

By applying the MOD_{Ni} normalization model learned over the smoothing duration, the method of the inventive concepts may generate values for each intermediate indicator KPI_{iA}, thus representing an indicator for a set of membranes considered new and/or cleaned and/or clean over a period extending beyond the D_{L} smoothing duration, e.g. over the acquisition period. The input to the normalization model is therefore the operating indicator KPIᵢ and possibly external physical parameters PARAᵢ. The output of the normalization model is the intermediate operating indicator KPI_{iA}.

In order to obtain a normalized operating indicator KPIᵢ′, the method of the inventive concepts comprises an operation aimed at combining together the values of the operating indicator KPIᵢ and the values of the intermediate operating indicator KPI_{iA} obtained by the learned normalization model MOD_{Ni} corresponding to a set of new and/or clean and/or cleaned membranes in order to produce a new time series SERIE_{2A}.

The third time series SERIE₃ refers to the values of the time series of the normalized operating indicator KPIᵢ′ or KPIᵢ₀′ that the method seeks to obtain.

According to one example, each normalization model has been learned over the D_{L} smoothing duration and is used to calculate the values of these intermediate operating indicators KPI_{1A}, KPI_{2A}, KPI_{3A}, KPI_{4A} over the entire acquisition period D_{A} from the values of the external physical parameters PARAᵢ under consideration and the values of the first, second, third and fourth indicators KPI₁, KPI₂, KPI₃, KPI₄ at the input of the normalization model learned over the entire acquisition period D_{A}. The values of the intermediate indicators KPI_{1A}, KPI_{2A}, KPI_{3A}, KPI_{4A} are used to represent indicators for a set of membranes considered new and/or cleaned and/or clean.

In order to obtain a normalized operating indicator KPIᵢ′ or KPIᵢ₀ reducing the effects induced by the influences of external physical parameters, the method of the inventive concepts comprises an operation aimed at combining together the values of the operating indicator KPIᵢ and the values obtained from the intermediate operating indicator KPI_{iA} by the learned normalization model corresponding to a set of new and/or clean and/or cleaned membranes in order to produce a new SERIE₃ time series.

Third Time Series KPI_{iA}, normalized operating indicator: KPIᵢ′.

When the intermediate operating indicator KPI_{iA} represented by the reference curve C_{REFi} is produced for each operating indicator KPIᵢ under consideration, the method of the inventive concepts generates a normalized operating indicator KPIᵢ′ or KPIᵢ₀′. To this end, the SERIE_{2A} time series produced by the learned normalization model is used to obtain a new SERIE₃ time series defining the normalized operating indicator KPIᵢ′ from an operation with another time series, for example the second SERIE₂ time series.

The step of generating the normalized operating indicator KPIᵢ′ is denoted GEN₁ in FIG. 1.

FIG. 8 shows a first curve representing the values of the first KPI₁ and a second curve representing the values of the first KPI_{1A}, said values being obtained with the learned normalization model.

According to a first example, the third time series SERIE₃ is generated by applying operations between the second time series SERIE₂ and the time series SERIE_{2A} corresponding to the corrected values produced by the learned normalization model, for example by subtracting them.

According to this second example, the third time series SERIE₃ corresponds to the subtraction of these two series SERIE₂ and SERIE_{2A} and leads to the deviations of the first indicator KPIᵢ attributed to membrane fouling. In other words, the previously introduced corrective term TC=KPIᵢ−KPI_{iA}.

This gives KPI₁′=TC=KPI₁−KPI_{1A} for the first operating indicator.

The normalized indicator KPIᵢ′ represents the term associated with the first indicator and related to the wear and clogging of the membranes of the first ENS₁ membrane assembly. The normalized operating indicator KPIᵢ′ is assumed to be independent of operating and environmental conditions.

According to a second example, the third SERIE₃ time series may correspond to a time series resulting from the subtraction of the two SERIE₂ and SERIE_{2A} series, to which a KPIᵢ₀ component has been added under average or standard environmental conditions. This latter component also takes the form of a time series.

This solution makes it possible to reintroduce standard environmental conditions to obtain normalized operating indicator values in the usual orders of magnitude forming comparables between them. In this case, it is possible to add indicator values taken according to standard reference conditions of physical parameters, such as a standard operating temperature T₀ and a standard average operating flow rate Qn₀.

For each operating indicator, we then have the equality:

$${KPI}_{i 0}^{′} = {KPI}_{i} - {KPI}_{iA} + {KPI}_{i A 0}$$

FIG. 9 shows the first normalized indicator KPI₁₀′ in the form of such a 3rd time series SERIE₃ obtained according to the 2nd example, i.e. obtained by subtracting the corrected parameter values KPI_{1A} from the SERIE_{2A} series from the KPI₁ values of the second SERIE₂ time series and summing the KPI_{1A0} values of the first indicator corresponding to a state of new and/or clean and/or cleaned membranes calculated with standard environmental conditions, i.e. with a standard operating temperature T₀ and a standard average operating flow rate Qn₀.

FIG. 9 shows that the normalized indicator KPI₁₀′ may be used to assess the evolution of the membrane assembly independently of variations in environmental conditions. This makes it possible to visualize changes in membrane condition, in particular aging and fouling, independently of variations in environmental conditions.

In particular, one advantage of generating a normalized indicator is that it provides a monitoring indicator that is independent of variables such as water temperature Ti, feed flow rate Qf, inlet pressure Pf and inlet conductivity Cf. Such an indicator has the advantage of varying primarily as a function of the state of wear and clogging, which is sought to prevent membrane replacement and cleaning.

Advantageously, this KPIᵢ₀′ data may be displayed to produce an indicator that evolves over time. An AFF₁ display is shown in FIG. 3 to illustrate an example of an operator console.

### Event Timestamp

According to an embodiment, the plant includes a set of maintenance operations which are membrane cleaning and/or replacement operations. These operations improve water filtration and enable the membranes to be used in their best operating range. The aim of the inventive concepts is to define a method for predicting maintenance operations. To this end, the method of the inventive concepts includes a step for learning a learning function. This learning may correspond to the regression operation of the normalization step, or to the learning of a prediction model detailed below. In order to obtain a training data set of good quality, the data relating to maintenance operations are time-stamped according to a time reference that may be used by operations processing time series, in particular the first and second SERIE₁, SERIE₂ time series. The time-stamping step is denoted HOR₁ in FIG. 1.

Consequently, when such operations are carried out in the plant, the method of the inventive concepts enables these events to be time-stamped and labeled so as to produce a set of time-stamped data which may then be used to implement a learning function such as a machine learning model to carry out a prediction step for a future maintenance operation.

The method of the inventive concepts includes a step of recording the time-stamped data according to the same time reference so as to match the time-stamped events with a time reference relative to the timestamp of each time series.

One advantage of time-stamping events is that it enables a machine learning model to take into account maintenance events that explain the discontinuity in the raw data acquired and recorded. This is particularly relevant in the case of long-term operation, which aims to measure the evolution of the normalized operating indicator over a long period.

The maintenance data timestamp may be used in a short-term prediction algorithm to define a set of training data between two timestamps so that data collected during maintenance operations does not noise the prediction.

The maintenance event time-stamping step is not necessary for the implementation of the inventive concepts process, which would aim solely at producing the normalized indicator, but it does enable better interpretation and/or learning to generate normalized operating indicator values.

### Short-Term Prediction

In one embodiment, the normalized KPIᵢ′ data is used to learn a learning function FA₂ such as a machine learning model, the so-called prediction model MOD_{Pi}. Such a prediction model MOD_{Pi} is defined by coefficients or parameters that are learned over a training period, referred to as the first prediction period Dₚ. In the case of short-term prediction, the method of the inventive concepts makes it possible to obtain a reliable prediction of the evolution of the normalized indicator KPIᵢ′ or KPIᵢ₀′. This predicted value is denoted KPIᵢₚ₁.

The GEN₂ step in FIG. 1 represents both the short-term prediction step and/or the long-term prediction step.

The advantage of such a predictive function is that it enables us to anticipate the next cleaning of the membranes in the first set of ENS₁ membranes.

According to various embodiments, the prediction model MOD_{Pi} may be a machine learning model built from a function implementing a second generalized additive model, denoted GAM₂, and from training data corresponding to the calculated values of the normalized indicator KPIᵢ′ or KPIᵢ₀′.

According to another example, the prediction model MOD_{Pi} may be built from a regression performed by a support vector machine model SVM from the training data corresponding to the calculated values of the normalized indicator KPIᵢ′ or KPIᵢ₀′.

According to an implementation example, an input vector comprises the calculated data of the normalized indicator KPIᵢ′ or KPIᵢ₀′, said data being acquired over a time window which may be a sliding window including the latest acquisitions. As an output of the prediction model MOD_{Pi}, predicted data of the KPIᵢₚ₁ operating indicator values, for example over several days, may be generated.

Advantageously, these short-term and/or long-term predictive data can be displayed to produce an indicator that evolves over time and enables maintenance operations to be planned. An AFF₁ display is shown in FIG. 3 to illustrate an example of an operator console.

### Long-Term Prediction

According to one embodiment, raw data received, acquired or read from a memory of the operating indicator KPIᵢ and normalized data of the calculated operating indicators, KPIᵢ′ or KPIᵢ₀′ are used. The data may be used to learn a learning function FA₃ such as a machine learning model. Such a prediction model MOD_{PLTi} is defined by coefficients or parameters that are learned over a training period, noted as the second prediction period D_{PLT}. In the case of a long-term prediction, the method of the inventive concepts makes it possible to obtain a prediction of the evolution of the normalized indicator KPIᵢ′ or KPIᵢ₀′. This predicted value is denoted KPIᵢₚ₂. The short-term prediction model MOD_{Pi} and the long-term prediction model MOD_{PLTi} are obtained from different trainings and therefore correspond to different models.

The advantage of such a predictive function FA₃ is to anticipate the next replacement of the first set of ENS₁ membranes.

According to various embodiments, the machine learning model may be a function implementing a recurrent neural network with a regression function based on an autoregressive method. According to another example, a regression performed by an LSTM-type model.

According to an implementation example, an input vector comprises the calculated data of the normalized indicator KPIᵢ′ or KPIᵢ₀′, said data being acquired over a time window defined between two maintenance events and a time series encoding the nature of the maintenance operations and the timestamps associated with these operations. The predicted data of the KPIᵢₚ₂ operating indicator values may comprise a long prediction period.

Advantageously, this data may be displayed to produce an indicator that evolves over time, enabling maintenance operations to be planned.

The inventive concepts also relates to a system for treating a volume of feed water into a volume of filter-treated water by means of a plurality of membrane assemblies. The water treatment system comprises a data processing system including hardware means for carrying out the method steps of the inventive concepts.

The inventive concepts therefore relates to a first data processing system and a second water treatment system, also known as a “plant”.

The water treatment system includes means for conveying a volume of water, such as a hydraulic pipe, to a water inlet to receive a flow of water entering at least a first set of membranes.

The water treatment system also includes a first filtered water outlet, known as the permeate, and a second residual water outlet, known as the concentrate. The water treatment system also includes a set of external parameter state sensors, including a water temperature sensor and at least one pressure sensor.

The water treatment system further comprises a data processing system including a computer, a memory, a clock and a communication interface for receiving data in time series form from the various sensors. The data processing system also includes a communication interface for transmitting the data to a server, said system including the server for carrying out steps for calculating a normalized indicator according to the method of the inventive concepts.

The instant description is provided as an enabling teaching of the disclosure in its best, currently known aspect. Those skilled in the relevant art will recognize that many changes can be made to the aspects described, while still obtaining the functional results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

As used herein, the singular forms “a”, “an”, and “the” include plural referents unless the context clearly dictates otherwise. Thus, for example, reference to a “body” includes aspects having two or more bodies unless the context clearly indicates otherwise. Ranges can be expressed herein as from “substantially” or “about” one particular value, and/or to “about” or “substantially” another particular value. When such a range is expressed, another aspect includes from the one particular value and/or to the other particular value.

Similarly, when values are expressed as approximations, by use of the antecedent “substantially” or “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

1-28. (canceled)

29. A method for an automated processing of data characterizing state of a plurality of membranes for filtration of a volume of liquid, comprising:
receiving a first set of data from state sensors arranged within or near a first set of membranes, said first set of membranes receiving an incoming water flow and generating a first outgoing water flow, called permeate, and a second outgoing water flow, called concentrate, said first set of data relating to external physical parameters, wherein the receiving of the first set of data is carried out according to a plurality of first time series of data emitted by each sensor at predefined frequencies;
determining at least one operating indicator of the first set of membranes, said at least one operating indicator defining a second time series of calculated or estimated data;
recording of the plurality of the first time series of data and the second time series of data over a given acquisition time, each time series of data defining a point cloud;
generating an intermediate operating indicator defining a point cloud corresponding to values of the intermediate operating indicator for which the first set of membranes is considered new and/or clean and/or cleaned, said values of the intermediate operating indicator being produced by applying a learned normalization model and from the intermediate operating indicator; and
generating a normalized operating indicator characterizing the state of the plurality of membranes for filtration of the volume of liquid, said state characterizing fouling and/or aging of the state of the plurality of membranes independent of variations in environmental conditions, said normalized operating indicator defining a third time series, said normalized operating indicator being obtained from the normalized operating indicator and the intermediate operating indicator.

30. The method of claim 29, wherein the normalization model is learned for each of the at least one operating indicator by means of a regression on the data of the second time series relating to the at least one operating indicator according to at least a first predefined external physical parameter from the plurality of the first time series of data, said regression being configured over a smoothing duration to determine a set of values corresponding substantially to within a factor of minima or maxima of the values of the second time series, said determined values corresponding to a configuration of new and/or clean and/or cleaned membrane(s).

31. The method of claim 29, wherein the normalization model is learned for each of the at least one operating indicator from a set of training data for said each of the at least one operating indicator over a smoothing duration comprising at least one maintenance and/or replacement operation on said first set of membranes.

32. The method of claim 30, wherein the determination of each of the at least one operating indicator comprises determining a first operating indicator defining a differential pressure between an inlet and an outlet of a membrane assembly and represented in form of the second time series of calculated or estimated data, the external physical parameters considered comprising at least one flow rate measurement and one temperature measurement, said external physical parameters being used to calculate the values of an intermediate indicator of the first operating indicator from the regression performed on the differential pressure values.

33. The method of claim 30, wherein the determination of the operating indicator comprises determination of a second operating indicator defining an inflow pressure into a first membrane assembly and represented in a form of the second time series of calculated or estimated data, the external physical parameters considered comprising at least one temperature measurement, a measurement of concentration of the inflow into the first set of membranes, a flow rate of the permeate flow and a flow rate of the concentrate flow from the first set of membranes, said external physical parameters being used to calculate the values of the intermediate indicator of the second operating indicator from the regression performed on the values of the inflow pressure in the first membrane assembly.

34. The method of claim 33, wherein the determination of the operating indicator comprises determining a third operating indicator defining a permeate flow rate at an outlet of the first membrane assembly and represented in the form of a second time series of calculated or estimated data, the external physical parameters considered comprising at least one temperature measurement, a measurement of the concentration of the inflow into the first set of membranes, the flow rate of the permeate flow and the flow rate of the concentrate flow from the first set of membranes, said external physical parameters being used to calculate the values of the intermediate indicator of the third operating indicator from the regression performed on the values of the permeate flow rate at the outlet of the first membrane assembly.

35. The method of claim 33, characterized in that the determination of the operating indicator comprises determining a fourth operating indicator defining a salt passage in the permeate leaving the first membrane assembly and represented in the form of a second time series of calculated or estimated data, the external physical parameters considered comprising at least one temperature measurement, a measurement of the concentration of the inflow into the first set of membranes, the flow rate of the permeate flow and the flow rate of the concentrate flow from the first set of membranes, the said external physical parameters being used to calculate the values of the intermediate indicator of the fourth operating indicator from the regression performed on the values of the salt passage in the permeate at an outlet of the first membrane assembly.

36. The method of claim 29, wherein the first data set corresponds to external physical parameters, the external physical parameters comprises at least one of:
a measurement of inflow, permeate flow and/or concentrate flow;
a measurement of conductivity of a volume of water;
a measurement of total organic carbon;
a target value corresponding to a conversion rate of a feed water volume into a treated water volume;
a characteristic value of the incoming flow corresponding to permeation flow; and
a characteristic value for a membrane's water permeability.

37. The method of claim 36, wherein the third time series corresponds to at least one of:
the time series obtained by subtracting the time series corresponding to corrected values produced by the learned model from the second time series; and
the time series obtained by subtracting the time series corresponding to corrected values produced by the learned model from the second time series and to which has been added a reference component corresponding to a time series of the operating indicator corresponding to at least one of a state of new, clean, and cleaned membranes, said component being calculated under average or standard environmental conditions.

38. The method of claim 30, wherein the regression on the operating indicator is performed according to a plurality of external physical parameters on which the operating indicator depends.

39. The method of claim 30, wherein the regression is implemented by means of a first learning function comprising a machine learning model with parameters learned through the implementation of a loss function.

40. The method of claim 39, wherein the regression is an expectile regression, the regression being performed on basis of an expectile loss function and an error function between the value of the operating indicator and a value estimated by the regression model for values of the operating indicator considered within a given expectile of distribution of values of the operating indicator.

41. The method of claim 30, wherein the regression is performed on the data of the second series of data of the operating indicator according to a plurality of predefined external physical parameters of a plurality of first time series obtained by a plurality of sensors, said regression being performed on basis of a generalized additive model modeling functions whose parameters are sought to be optimized by means of an expectation loss function between the value of the calculated operating indicator and the value of an estimated operating indicator within range of values of the predefined expectation and for given values of external physical parameters, said regression further modeling an error function and said regression being run over a smoothing duration, said regression generating a set of values of a point cloud defining the intermediate indicator, said set of values corresponding to a new and/or clean and/or cleaned state of the first set of membranes.

42. The method of claim 41, wherein the smoothing duration is determined so as to include a plurality of event markers relating to maintenance of membrane assemblies, said smoothing duration being less than an acquisition duration.

43. The method of claim 42, further comprising a time-stamping of events (relating to the maintenance of membrane assemblies, said events corresponding to cleaning and/or replacement, each time-stamping being performed according to a marked time reference within the acquisition duration.

44. The method of claim 29, wherein the generation of values of a predicted operating indicator by application of a second learning function trained from the values of the normalized operating indicator corresponding to the third time series considered over a prediction duration, said second learning function generating predicted data for an evolution of the normalized indicator.

45. The method of claim 44, wherein the training data for training the second learning function are selected between last two event timestamps associated respectively with two successive cleanings, a new training of the second learning function being triggered after each new event associated with a cleaning.

46. The method of claim 44, further comprising a comparison of at least one predicted value of a normalized indicator with at least one predefined threshold, said comparison making it possible to generate a cleaning date.

47. The method of claim 46, wherein the predefined threshold is a variable threshold whose value is generated by execution of a function dependent on predefined parameters.

48. The method of claim 44, wherein the second learning function is a function implementing a second generalized additive model.

49. The method of claim 42, further comprising a calculation of an aging index of a set of membranes from a third learning function, said third learning function comprising a set of training data comprising the values extracted from the first set of data used to estimate an indicator in question, the set of training data being selected over the acquisition duration and taking into account timestamps of the events occurring during the acquisition duration.

50. The method of claim 46, wherein the third learning function is a recurrent neural network comprising a regression function based on an autoregressive method.

51. A data processing system, comprising:
a computer;
a memory;
a clock and a communication interface for receiving data in form of a time series;
a communication interface for transmitting the data to a server, wherein the server is configured to perform steps for calculating a normalized operating indicator, the steps comprising,
receiving a first set of data from state sensors arranged within or near a first set of membranes, said first set of membranes receiving an incoming water flow and generating a first outgoing water flow, called permeate, and a second outgoing water flow, called concentrate, said first set of data relating to external physical parameters, wherein the receiving of the first set of data is carried out according to a plurality of first time series of data emitted by each sensor at predefined frequencies;
determining at least one operating indicator of the first set of membranes, said at least one operating indicator defining a second time series of calculated or estimated data;
recording of the plurality of the first time series of data and the second time series of data over a given acquisition time, each time series of data defining a point cloud;
generating an intermediate operating indicator defining a point cloud corresponding to values of the intermediate operating indicator for which the first set of membranes is considered new and/or clean and/or cleaned, said values of the intermediate operating indicator being produced by applying a learned normalization model and from the intermediate operating indicator; and
generating a normalized operating indicator characterizing the state of the plurality of membranes for filtration of volume of liquid, said state characterizing fouling and/or aging of the state of the plurality of membranes independent of variations in environmental conditions, said normalized operating indicator defining a third time series, said normalized operating indicator being obtained from the normalized operating indicator and the intermediate operating indicator.

52. The system of claim 51, further comprising a display for generating in real time a representation of at least one normalized indicator.

53. A system for treatment of a volume of feed water into a volume of filter-treated water by means of a plurality of membrane assemblies, comprising:
a water inlet for receiving a flow of water entering at least one given membrane assembly;
a first filtered water outlet, so-called permeate;
a second residual water outlet called concentrate;
a set of external parameter state sensors including a water temperature sensor and at least one pressure sensor; and
a data processing system comprising:
a computer;
a memory;
a clock and a communication interface for receiving data in form of a time series;
a communication interface for transmitting the data to a server, wherein the server is configured to perform steps for calculating a normalized operating indicator, the steps comprising,
receiving a first set of data from state sensors arranged within or near a first set of membranes, said first set of membranes receiving an incoming water flow and generating a first outgoing water flow, called permeate, and a second outgoing water flow, called concentrate, said first set of data relating to external physical parameters, wherein the receiving of the first set of data is carried out according to a plurality of first time series of data emitted by each sensor at predefined frequencies;
determining at least one operating indicator of the first set of membranes, said at least one operating indicator defining a second time series of calculated or estimated data;
recording of the plurality of the first time series of data and the second time series of data over a given acquisition time, each time series of data defining a point cloud;
generating an intermediate operating indicator defining a point cloud corresponding to values of the intermediate operating indicator for which the first set of membranes is considered new and/or clean and/or cleaned, said values of the intermediate operating indicator being produced by applying a learned normalization model and from the intermediate operating indicator; and
generating a normalized operating indicator characterizing the state of the plurality of membranes for filtration of the volume of liquid, said state characterizing fouling and/or aging of the state of the plurality of membranes independent of variations in environmental conditions, said normalized operating indicator defining a third time series, said normalized operating indicator being obtained from the normalized operating indicator and the intermediate operating indicator.

54. The system of claim 51, further comprising a plurality of membranes organized according to a plurality of sets of membranes, each set of membranes defining a stage for treating an input volume of water and generating an output flow.

55. The system of claim 51, further comprising at least one second set of membranes arranged at an outlet of the first set of membranes, the concentrate of the first set of membranes defining an inlet of the second set of membranes.

56. The system of claim 51, further comprising at least one third membrane assembly arranged in parallel with a first membrane assembly, the concentrate from the first membrane assembly and the at least one third membrane assembly defining an inlet to a second membrane assembly.
